(19) United States
(12) Patent Application Publication
(10) Pub. No.: US 2025/0305563 A1
(43) Pub. Date: Oct. 2, 2025

(54) SMALL ACTUATOR

(71) Applicant: KOREA INSTITUTE OF SCIENCE AND TECHNOLOGY, Seoul (KR)

(72) Inventors: Donghyun HWANG, Seoul (KR); Sungwoo PARK, Seoul (KR)

(73) Assignee: KOREA INSTITUTE OF SCIENCE AND TECHNOLOGY, Seoul (KR)

(21) Appl. No.: 19/037,677

(22) Filed: Jan. 27, 2025

(30) Foreign Application Priority Data
Mar. 29, 2024 (KR) 10-2024-0043726

(51) Int. Cl. F16H 19/08; F16H 57/02; F16H 57/021; H02K 7/116; H02K 11/215; H02K 11/27; H02K 11/33

(52) U.S. Cl. CPC F16H 19/08; F16H 57/021; H02K 7/116; H02K 11/215; H02K 11/27; H02K 11/33; F16H 2057/02034; F16H 2057/02073; H02K 2211/03

(57) ABSTRACT

A small actuator is provided. The small actuator includes a housing; a motor disposed in the housing and including a motor gear; a first transmission gear including a first gear unit in external contact with the motor gear and a second gear unit formed integrally with the first gear unit; a second transmission gear including a third gear unit in external contact with the second gear unit and a fourth gear unit formed integrally with the third gear unit; a third transmission gear including a fifth gear unit in external contact with the fourth gear unit and a sixth gear unit formed integrally with the fifth gear unit; a fourth transmission gear including a seventh gear unit in external contact with the sixth gear unit and an eighth gear unit formed integrally with the seventh gear unit; and an output shaft including an output gear in external contact with the eighth gear unit.

### CROSS-REFERENCE TO RELATED APPLICATIONS

This application claims the benefit of Korea Patent Application No. 10-2024-0043726, filed on Mar. 29, 2024, which is incorporated herein by reference for all purposes as if fully set forth herein.

### TECHNICAL FIELD

The present disclosure relates to a small actuator.

### BACKGROUND

Robots are used in various forms. When looking at the mechanical configuration of the robot, the robot includes a plurality of rotary joints, and each rotary joint is equipped with an actuator that enables a rotary motion.

Recently, with the automation of factories and the advancement and unmanned operation of each industrial site, the demand for collaborative robots in the form of manipulators is increasing. In terms of the demand for the collaborative robots, miniaturization, high output, and precision are performance items that require continuous improvement.

To this end, small actuators which are small, high output, and precise are required.

Examples of small actuators applied to rotary joints or ends of the robot include a small actuator from ROBOTIS and AK10-9 actuator from CubeMars.

The small actuator from ROBOTIS can be used by connecting actuators using 3 or 4 wires and mounting the actuators on joints or ends of the robot. However, the small actuator had problems in that it was difficult to attach the actuator to the joint as a direct drive type because it had limitations in size, it was difficult to reflect a force or a position measured from the robot for control in real time, and it was difficult to predict a force generated due to interaction.

In addition, the AK10-9 actuator from CubeMars had a problem in that it was difficult to attach the AK10-9 actuator to the joints or ends of the robot due to its size because the AK10-9 actuator was required to generate a large torque at a low reduction ratio due to a structure of the actuator.

### SUMMARY

An object of the present disclosure is to provide a small actuator having a low inertia and a high gear ratio.

Another object of the present disclosure is to provide a small actuator capable of detecting a rotation angle of an output shaft.

Another object of the present disclosure is to provide a small actuator capable of detecting a torque by detecting a current flowing into a motor.

Another object of the present disclosure is to provide a small actuator capable of improving space efficiency.

In an aspect of the present disclosure, there is provided a small actuator comprising a housing; a motor disposed in the housing, the motor including a motor gear; a first transmission gear including a first gear unit in external contact with the motor gear and a second gear unit formed integrally with the first gear unit; a second transmission gear including a third gear unit in external contact with the second gear unit and a fourth gear unit formed integrally with the third gear unit; a third transmission gear including a fifth gear unit in external contact with the fourth gear unit and a sixth gear unit formed integrally with the fifth gear unit; a fourth transmission gear including a seventh gear unit in external contact with the sixth gear unit and an eighth gear unit formed integrally with the seventh gear unit; and an output shaft including an output gear in external contact with the eighth gear unit.

In this case, the second transmission gear and the fourth transmission gear may vertically overlap each other, and the third transmission gear and the output shaft may vertically overlap each other.

Specifically, the second transmission gear, the third transmission gear, the fourth transmission gear, and the output gear may be sequentially arranged in zigzag.

The third gear unit may vertically overlap the seventh gear unit as a whole, and the output gear may vertically overlap the fifth gear unit as a whole.

A diameter of the third gear unit may be greater than a diameter of the fourth gear unit, and a diameter of the seventh gear unit may be greater than a diameter of the eighth gear unit. A diameter of the fifth gear unit may be greater than a diameter of the sixth gear unit.

Through this, the small actuator having a low inertia and a high gear ratio can be implemented.

The motor may be a coreless direct current motor with a low inertia.

The small actuator may further comprise a magnet disposed on the output shaft and below the third transmission gear, a substrate disposed in the housing, and a magnet sensor disposed on the substrate and facing the magnet.

Through this, the small actuator can detect a rotation angle of the output shaft.

The housing may include a first housing, a second housing disposed below the first housing, and a third housing connecting the first housing and the second housing. The output shaft may be rotatably coupled to the third housing through a bearing.

The small actuator may further comprise a current sensor disposed on the substrate, and the current sensor may detect a current flowing into the motor.

Through this, the small actuator can detect a torque by detecting the current flowing into the motor.

The substrate may include an inner substrate coupled to the second housing and an outer substrate that is electrically connected to the inner substrate and is disposed outside the housing. The magnet sensor, the current sensor, and a motor drive may be arranged on the inner substrate, and a controller may be disposed on the outer substrate.

The small actuator may further comprise a motor drive disposed on the substrate and controlling an operation of the motor, and a controller disposed on the substrate and electrically connected to the current sensor and the motor drive. The controller may predict a torque of the small actuator through the current flowing into the motor detected by the current sensor, and control the operation of the motor through the motor drive based on the predicted torque of the small actuator.

The third transmission gear may be rotatably coupled to the output shaft.

The housing may include a first housing, a second housing disposed below the first housing, and a third housing connecting the first housing and the second housing. The small actuator may further comprise a rotation shaft that is disposed inside the first transmission gear and is formed integrally with the first transmission gear. The rotation shaft may be rotatably coupled to the third housing.

The small actuator may further comprise a fixing shaft, in which an upper portion of the fixing shaft is coupled to the first housing, and a lower portion of the fixing shaft is coupled to the third housing. Each of the second transmission gear and the fourth transmission gear may be rotatably coupled to the fixing shaft.

Through this, the small actuator can improve the space efficiency.

An embodiment of the present disclosure can provide a small actuator having a low inertia and a high gear ratio.

An embodiment of the present disclosure can provide a small actuator capable of detecting a rotation angle of an output shaft.

An embodiment of the present disclosure can provide a small actuator capable of detecting a torque by detecting a current flowing into a motor.

An embodiment of the present disclosure can provide a small actuator capable of improving space efficiency.

### BRIEF DESCRIPTION OF THE DRAWINGS

The accompanying drawings, which are included to provide a further understanding of the present disclosure and constitute a part of the detailed description, illustrate embodiments of the present disclosure and serve to explain technical features of the present disclosure together with the description.

FIG. 1 is a perspective view of a small actuator according to an embodiment of the present disclosure.

FIG. 2 is an exploded perspective view of a small actuator according to an embodiment of the present disclosure.

FIG. 3 is a front view of a part of a small actuator according to an embodiment of the present disclosure.

FIGS. 4 and 5 illustrate the distribution of normalized logarithmic values of inertia of a small actuator according to an embodiment of the present disclosure.

FIG. 6 is a graph illustrating a backdrivability generation torque over time in a small actuator according to a prior art and a small actuator according to an embodiment of the present disclosure.

FIGS. 7 and 8 illustrate a substrate of a small actuator according to an embodiment of the present disclosure.

FIG. 9 is a circuit diagram of a small actuator according to an embodiment of the present disclosure.

FIG. 10 is a part of a circuit diagram of a small actuator according to an embodiment of the present disclosure.

FIG. 11 is a graph illustrating a voltage and a current over time in a small actuator according to an embodiment of the present disclosure.

FIG. 12 is a graph illustrating a rotation angle of a magnet over time in a small actuator according to an embodiment of the present disclosure.

FIG. 13 is a graph illustrating a relationship between an actual rotation angle and a reference rotation angle of a magnet of a small actuator according to an embodiment of the present disclosure.

FIG. 14 is a graph illustrating a relationship between an input voltage and a measured current in a small actuator according to an embodiment of the present disclosure.

FIG. 15 is a graph illustrating a relationship between a measured current and torque in a small actuator according to an embodiment of the present disclosure.

### DETAILED DESCRIPTION

Reference will now be made in detail to embodiments of the present disclosure, examples of which are illustrated in the accompanying drawings.

The technical spirit of the present disclosure is not limited to some embodiments described, and can be implemented in various different forms. Embodiments of the present disclosure can selectively combine or substitute one or more of components within the scope of the technical spirit of the present disclosure.

Terms (including technical and scientific terms) used in embodiments of the present disclosure, unless explicitly defined and described, can be interpreted as having the meanings as commonly understood by those skilled in the technical field to which the present disclosure pertains, and commonly used terms such as terms defined in the dictionary can be interpreted considering the meanings of the context of the related art.

In addition, the terms used in embodiments of the present disclosure are for describing embodiments and are not intended to limit the present disclosure.

In the present disclosure, the singular forms may also include plural forms unless otherwise specifically stated in a phrase. In case that “at least one (or one or more) of A, B or C” is described, it may include one or more of all combinations that may be combined by A, B, and C.

In the description of the components of embodiments of the present disclosure, the terms such as first, second, A, B, (a), and (b) may be used. These terms are merely used to distinguish the components from other components, and do not delimit an essence, an order or a sequence of the corresponding components.

In addition, when it is described that a component is “connected”, “coupled”, or “jointed” to other component, the description may include not only being directly connected, coupled or joined to the other component but also being “connected” “coupled” or “joined” by another component between the component and the other component.

In the case of being described as being formed or disposed “above (on)” or “below (under)” of each component, the description includes not only when two components are in direct contact with each other, but also when one or more other components are formed or disposed between the two components. In addition, when expressed as “above (on)” or “below (under),” it may refer to a downward direction as well as an upward direction with respect to one component.

Embodiments of the present disclosure are described in detail below with reference to the accompanying drawings.

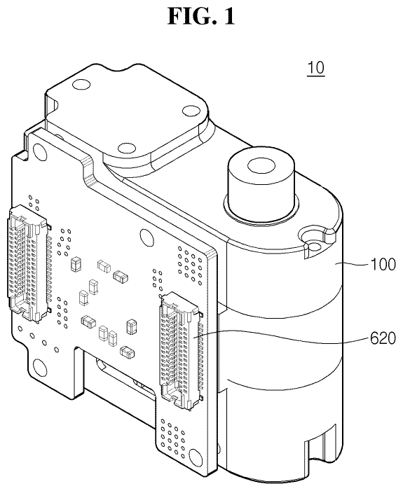

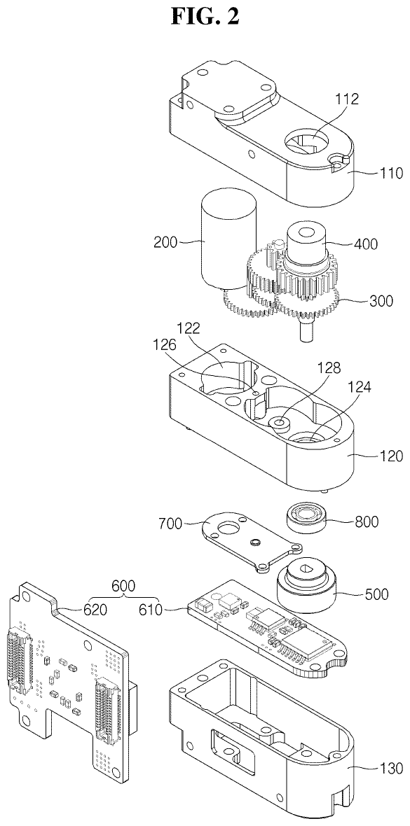

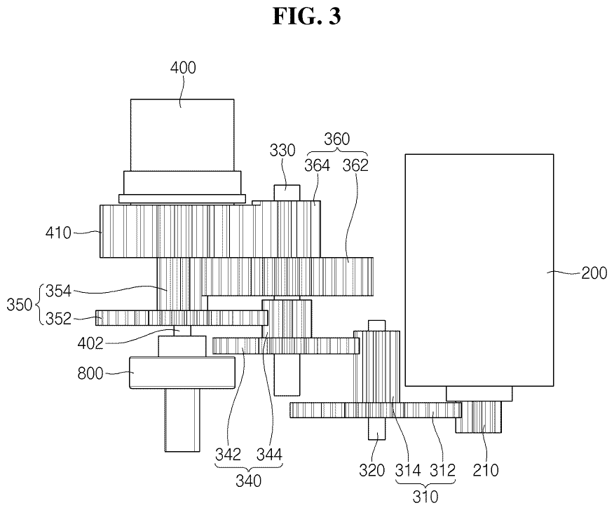

FIG. 1 is a perspective view of a small actuator according to an embodiment of the present disclosure. FIG. 2 is an exploded perspective view of a small actuator according to an embodiment of the present disclosure. FIG. 3 is a front view of a part of a small actuator according to an embodiment of the present disclosure.

Referring to FIGS. 1 to 3, a small actuator 10 according to an embodiment of the present disclosure may include a housing 100, a motor 200, a transmission gear 300, an output shaft 400, a magnet 500, a substrate 600, a fixing member 700, and a bearing 800, but may be implemented excluding some of the components, and additional components are not excluded.

The small actuator 10 may be applied to a terminal device or a joint, etc. of a robot with a narrow space as a small actuator, but is not limited thereto and can be utilized in various fields. For example, the terminal device of the robot may include a gripper for grasping an object or a robot hand, or the like. Since the small actuator 10 uses a modular structure in which a signal processing device, a sensor, and a driver are built in, the small actuator 10 does not require a separate signal processing device and is easy to maintain. The small actuator 10 is light in weight and has good backdrivability using a low-inertia gear and a low-inertia motor. The small actuator 10 can communicate with the outside. The small actuator 10 can predict a torque based on a current signal and thus can perform fast torque feedback and control.

The housing 100 may form an appearance of the small actuator 10. The motor 200, the transmission gear 300, the output shaft 400, the magnet 500, the substrate 600, the fixing member 700, and the bearing 800 may be arranged in the housing 100. A portion of the substrate 600 may be disposed outside the housing 100. The housing 100 may be formed in an overall hexahedral shape.

The housing 100 may include a first housing 110, a second housing 130 disposed below the first housing 110, and a third housing 120 connecting the first housing 110 and the second housing 130.

A first coupling hole may be formed in an upper surface of the third housing 120, and a first coupling protrusion may be formed on a lower surface of the first housing 110 and inserted into the first coupling hole of the third housing 120. A second coupling hole may be formed in an upper surface of the second housing 130, and a second coupling protrusion may be formed on a lower surface of the third housing 120 and inserted into the second coupling hole of the second housing 130.

The motor 200, the transmission gear 300, and the output shaft 400 may be arranged in a space between the first housing 110 and the third housing 120. The first housing 110 may include an output hole 112 through which the output shaft 400 passes.

The fixing member 700, an inner substrate 610, and the magnet 500 may be arranged in a space between the third housing 120 and the second housing 130.

The third housing 120 may include a bearing mounting hole 124 through which the output shaft 400 passes, and the bearing 800 may be coupled to the bearing mounting hole 124. The third housing 120 may include a motor hole 122 in which a lower area of the motor 200 is mounted, and a portion of the lower area of the motor 200 may pass through the motor hole 122. The third housing 120 may include a rotation hole 126 to which a rotation shaft 320 disposed inside a first transmission gear 310 is rotatably coupled. The third housing 120 may include a fixing hole 128 through which a fixing shaft 330 disposed inside a second transmission gear 340 and a fourth transmission gear 360 passes.

The motor 200 may be disposed in the housing 100. Specifically, the motor 200 may be disposed in the space between the first housing 110 and the third housing 120. The lower area of the motor 200 may be seated in an upper area of the motor hole 122 of the third housing 120. The lower area of the motor 200 may pass through the motor hole 122 of the third housing 120. The motor 200 may be a coreless direct current (DC) motor with low inertia.

The motor 200 may include a motor gear 210. The motor gear 210 may be disposed in the lower area of the motor 200. The motor gear 210 may rotate clockwise or counterclockwise based on the rotation of a motor shaft of the motor 200. The motor gear 210 may be in external contact with the first transmission gear 310. The motor gear 210 may be disposed below the third housing 120. The motor gear 210 may penetrate a portion of the fixing member 700.

The transmission gear 300 may be in external contact with the motor gear 210 of the motor 200. The transmission gear 300 may be in external contact with the output shaft 400. The transmission gear 300 may have a high gear ratio. Through this, the transmission gear 300 may reduce an output of the motor 200 and transmit it to the output shaft 400.

The transmission gear 300 may include the first transmission gear 310. The first transmission gear 310 may be in external contact with the motor gear 210. The first transmission gear 310 may include a first gear unit 312 in external contact with the motor gear 210 and a second gear unit 314 integrally formed with the first gear unit 312.

The first gear unit 312 may horizontally overlap the motor gear 210. A diameter of the first gear unit 312 may be greater than a diameter of the motor gear 210. The number of teeth of the first gear unit 312 may be more than the number of teeth of the motor gear 210. A vertical length of the first gear unit 312 may be less than a vertical length of the motor gear 210.

The second gear unit 314 may be disposed above the first gear unit 312. A vertical length of the second gear unit 314 may be longer than the vertical length of the first gear unit 312. A diameter of the second gear unit 314 may be less than the diameter of the first gear unit 312. The number of teeth of the second gear unit 314 may be less than the number of teeth of the first gear unit 312. The second gear unit 314 may be in external contact with the second transmission gear 340. The second gear unit 314 may be in external contact with a third gear unit 342. The second gear unit 314 may horizontally overlap the bearing 800. The second gear unit 314 may be disposed below the third housing 120. The second gear unit 314 may be disposed between the third housing 120 and the fixing member 700.

The rotation shaft 320 may be disposed inside the first transmission gear 310. The rotation shaft 320 may rotate integrally with the first transmission gear 310. The rotation shaft 320 may pass through the first transmission gear 310. The rotation shaft 320 may be formed integrally with the first transmission gear 310. The rotation shaft 320 may be rotatably coupled to the third housing 120. Specifically, an upper area of the rotation shaft 320 may be rotatably coupled to a rotation hole 126 of the third housing 120, and a lower area of the rotation shaft 320 may be rotatably coupled to the fixing member 700. Oil may be provided between the rotation shaft 320 and the rotation hole 126 and between the rotation shaft 320 and the fixing member 700 to provide a low frictional force.

The transmission gear 300 may include the second transmission gear 340. The second transmission gear 340 may be in external contact with the first transmission gear 310. The second transmission gear 340 may include the third gear unit 342 in external contact with the second gear unit 314 of the first transmission gear 310, and a fourth gear unit 344 integrally formed with the third gear unit 342. The second transmission gear 340 may be rotatably coupled to the fixing shaft 330. The second transmission gear 340 may be penetrated by the fixing shaft 330. Oil may be provided between the second transmission gear 340 and the fixing shaft 330 to reduce a frictional force.

The third gear unit 342 may horizontally overlap the second gear unit 314. A diameter of the third gear unit 342 may be greater than the diameter of the second gear unit 314. The number of teeth of the third gear unit 342 may be more than the number of teeth of the second gear unit 314. A vertical length of the third gear unit 342 may be less than the vertical length of the second gear unit 314. The third gear unit 342 may be disposed in the space between the first housing 110 and the third housing 120. The third gear unit 342 may vertically overlap a seventh gear unit 362 as a whole.

The fourth gear unit 344 may be disposed above the third gear unit 342. A vertical length of the fourth gear unit 344 may be greater than the vertical length of the third gear unit 342. A diameter of the fourth gear unit 344 may be less than the diameter of the third gear unit 342. The number of teeth of the fourth gear unit 344 may be less than the number of teeth of the third gear unit 342. The fourth gear unit 344 may be in external contact with a third transmission gear 350. The fourth gear unit 344 may be in external contact with a fifth gear unit 352. The fourth gear unit 344 may be disposed in the space between the first housing 110 and the third housing 120.

The fixing shaft 330 may be disposed inside the second transmission gear 340 and the fourth transmission gear 360. The fixing shaft 330 may pass through the second transmission gear 340 and the fourth transmission gear 360. The fixing shaft 330 may be coupled and fixed to the housing 100. An upper area of the fixing shaft 330 may be coupled and fixed to the first housing 110. A lower area of the fixing shaft 330 may be coupled and fixed to the third housing 120. The lower area of the fixing shaft 330 may be inserted and fixed into the fixing hole 128 of the third housing 120.

The transmission gear 300 may include the third transmission gear 350. The third transmission gear 350 may be in external contact with the second transmission gear 340. The third transmission gear 350 may include the fifth gear unit 352 in external contact with the fourth gear unit 344 and a sixth gear unit 354 integrally formed with the fifth gear unit 352. The third transmission gear 350 may be rotatably coupled to the output shaft 400. The third transmission gear 350 may be disposed above the bearing 800.

The fifth gear unit 352 may horizontally overlap the fourth gear unit 344. A diameter of the fifth gear unit 352 may be greater than the diameter of the fourth gear unit 344. The number of teeth of the fifth gear unit 352 may be more than the number of teeth of the fourth gear unit 344. A vertical length of the fifth gear unit 352 may be less than the vertical length of the fourth gear unit 344. The fifth gear unit 352 may be penetrated by the output shaft 400. A portion of the fifth gear unit 352 may be vertically arranged between the third gear unit 342 and the seventh gear unit 362.

The sixth gear unit 354 may be disposed above the fifth gear unit 352. A vertical length of the sixth gear unit 354 may be greater than the vertical length of the fifth gear unit 352. A diameter of the sixth gear unit 354 may be less than the diameter of the fifth gear unit 352. The number of teeth of the sixth gear unit 354 may be less than the number of teeth of the fifth gear unit 352. The sixth gear unit 354 may be in external contact with the fourth transmission gear 360. The sixth gear unit 354 may be in external contact with the seventh gear unit 362. The sixth gear unit 354 may be penetrated by the output shaft 400.

The transmission gear 300 may include the fourth transmission gear 360. The fourth transmission gear 360 may be in external contact with the third transmission gear 350. The fourth transmission gear 360 may include the seventh gear unit 362 in external contact with the sixth gear unit 354, and an eighth gear unit 364 integrally formed with the seventh gear unit 362. The fourth transmission gear 360 may be rotatably coupled to the fixing shaft 330. The fourth transmission gear 360 may be penetrated by the fixing shaft 330. The fourth transmission gear 360 may be disposed above the second transmission gear 340. The fourth transmission gear 360 may be vertically spaced from the second transmission gear 340. Oil may be provided between the fourth transmission gear 360 and the fixing shaft 330 to reduce a frictional force.

The seventh gear unit 362 may horizontally overlap the sixth gear unit 354. A diameter of the seventh gear unit 362 may be greater than the diameter of the sixth gear unit 354. The number of teeth of the seventh gear unit 362 may be more than the number of teeth of the sixth gear unit 354. A vertical length of the seventh gear unit 362 may be less than the vertical length of the sixth gear unit 354. The seventh gear unit 362 may be disposed in the space between the first housing 110 and the third housing 120. A portion of the seventh gear unit 362 may be vertically disposed between the fifth gear unit 352 and an output gear 410.

The eighth gear unit 364 may be disposed above the seventh gear unit 362. A vertical length of the eighth gear unit 364 may be greater than the vertical length of the seventh gear unit 362. A diameter of the eighth gear unit 364 may be less than the diameter of the seventh gear unit 362. The number of teeth of the eighth gear unit 364 may be less than the number of teeth of the seventh gear unit 362. The eighth gear unit 364 may be in external contact with the output gear 410. The eighth gear unit 364 may be disposed in the space between the first housing 110 and the third housing 120.

The output shaft 400 may vertically extend. The output shaft 400 may be in external contact with the transmission gear 300. Specifically, the output shaft 400 may include the output gear 410 in external contact with the fourth transmission gear 360 of the transmission gear 300. The output gear 410 may be formed integrally with the output shaft 400 and may rotate integrally with the output shaft 400. The output gear 410 may be in external contact with the eighth gear unit 364 of the fourth transmission gear 360. The output gear 410 may be disposed above the third transmission gear 350. The output gear 410 may be vertically spaced apart from the third transmission gear 350. A diameter of the output gear 410 may be greater than the diameter of the eighth gear unit 364. The number of teeth of the output gear 410 may be more than the number of teeth of the eighth gear unit 364. A vertical length of the output gear 410 may be less than the vertical length of the eighth gear unit 364. The output gear 410 may vertically overlap the fifth gear unit 352 as a whole.

The bearing 800 may be coupled to the output shaft 400. The bearing 800 may be coupled to a lower area of the output shaft 400. The output shaft 400 may pass through the bearing 800. The output shaft 400 may be rotatably coupled to the third housing 120 through the bearing 800. Specifically, the output shaft 400 may be rotatably coupled to the bearing mounting hole 124 of the third housing 120 through the bearing 800. The lower area of the output shaft 400 may pass through the bearing mounting hole 124 of the third housing 120. An upper area of the output shaft 400 may protrude upward from the first housing 110. The upper area of the output shaft 400 may be connected to an external device.

The second transmission gear 340 and the fourth transmission gear 360 may vertically overlap with each other. The third transmission gear 350 and the output shaft 400 may vertically overlap with each other. Specifically, the second transmission gear 340, the third transmission gear 350, the fourth transmission gear 360, and the output gear 410 may be sequentially arranged in zigzag. Through this, the small actuator 10 having a low inertia and a high gear ratio can be implemented.

The magnet 500 may be arranged on the output shaft 400. The magnet 500 may be coupled to the lower area of the output shaft 400. The magnet 500 may integrally rotate based on the rotation of the output shaft 400. The magnet 500 may be disposed in a space between the second housing 130 and the third housing 120. The magnet 500 may be formed in a cylindrical shape, but is not limited thereto. For example, the shape of the magnet 500 may be variously changed. The magnet 500 may be disposed below the bearing 800. A portion 402 of the output shaft 400 disposed between the magnet 500 and the bearing 800 may horizontally overlap the first gear unit 312.

The fixing member 700 may be disposed in the housing 100. The fixing member 700 may be coupled to the third housing 120. The fixing member 700 may be disposed below the third housing 120. The fixing member 700 may be penetrated by a lower area of the motor gear 210. The fixing member 700 may be rotatably coupled to the lower area of the rotation shaft 320.

The bearing 800 may be coupled to the output shaft 400. The bearing 800 may be disposed in the housing 100. The bearing 800 may be coupled to the third housing 120. The bearing 800 may be seated in the bearing mounting hole 124 of the third housing 120. The bearing 800 may be penetrated by the output shaft 400. The bearing 800 may be coupled to the third housing 120 to allow the output shaft 400 to rotate with respect to the third housing 120. The bearing 800 may be disposed between the magnet 500 and the third transmission gear 350.

The substrate 600 may be disposed in the housing 100. Specifically, the substrate 600 may be disposed in the space between the second housing 130 and the third housing 120. The substrate 600 may include the inner substrate 610 that is disposed below the motor 200, the transmission gear 300, and the output shaft 400, and an outer substrate 620 that is electrically connected to the inner substrate 610 and is disposed outside the housing 100. The inner substrate 610 may be coupled to the second housing 130.

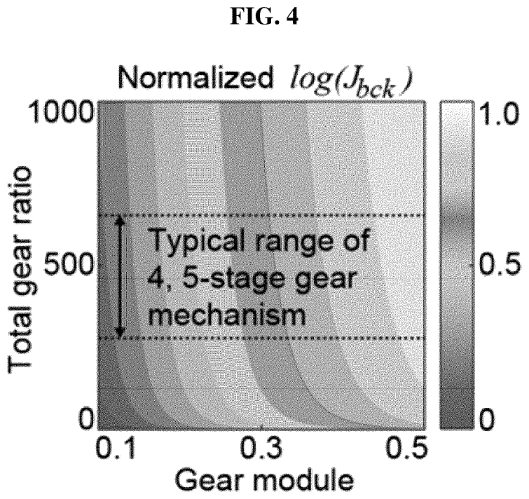

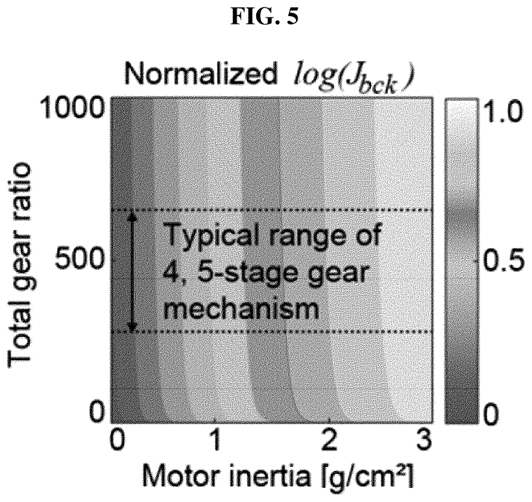

FIGS. 4 and 5 illustrate the distribution of normalized logarithmic values of inertia of a small actuator according to an embodiment of the present disclosure.

It can be seen from FIG. 4 that the transmission gear 300 of the small actuator 10 according to an embodiment of the present disclosure simultaneously has a high gear ratio and a low gear module, and thus normalized logarithmic values of inertia of the small actuator 10 are low.

It can be seen from FIG. 5 that the motor 200 of the small actuator 10 according to an embodiment of the present disclosure is a low-inertia DC motor, and thus normalized logarithmic values of inertia of the small actuator 10 are low due to a low motor inertia.

In other words, since the small actuator 10 according to an embodiment of the present disclosure has the low gear module and the low motor inertia, the small actuator 10 is light in weight and has high backdrivability due to the low normalized logarithmic values of the inertia. At the same time, the small actuator 10 has the high gear ratio, and thus obtains an increase in usability.

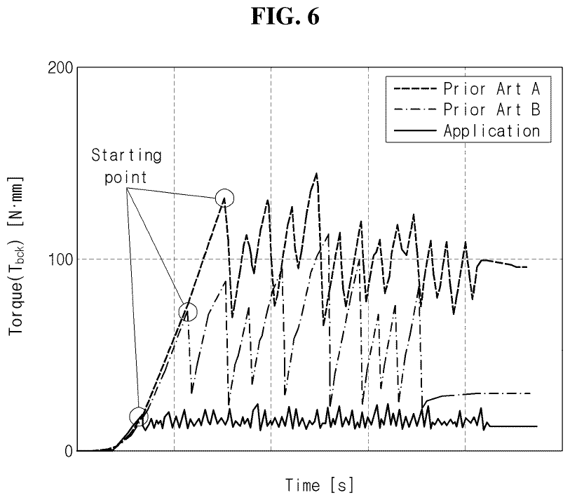

FIG. 6 is a graph illustrating a backdrivability generation torque over time in a small actuator according to a prior art and a small actuator according to an embodiment of the present disclosure.

It can be seen from FIG. 6 that a backdrivability generation torque over time in the small actuator 10 according to an embodiment of the present disclosure was lower than that of a prior art A and a prior art B. Specifically, the backdrivability generation torque over time in the small actuator 10 according to an embodiment of the present disclosure was 6 times lower than that of the prior art A and 4.6 times lower than that of the prior art B. In this case, when a thread and a pulley were connected to the small actuator 10 and an external stage moved in a state in which power was not applied to the small actuator 10, a force transmitted through the thread was measured.

In summary, the small actuator 10 according to an embodiment of the present disclosure has the high backdrivability, and thus the current transmitted to the motor can be precisely measured even at a low torque.

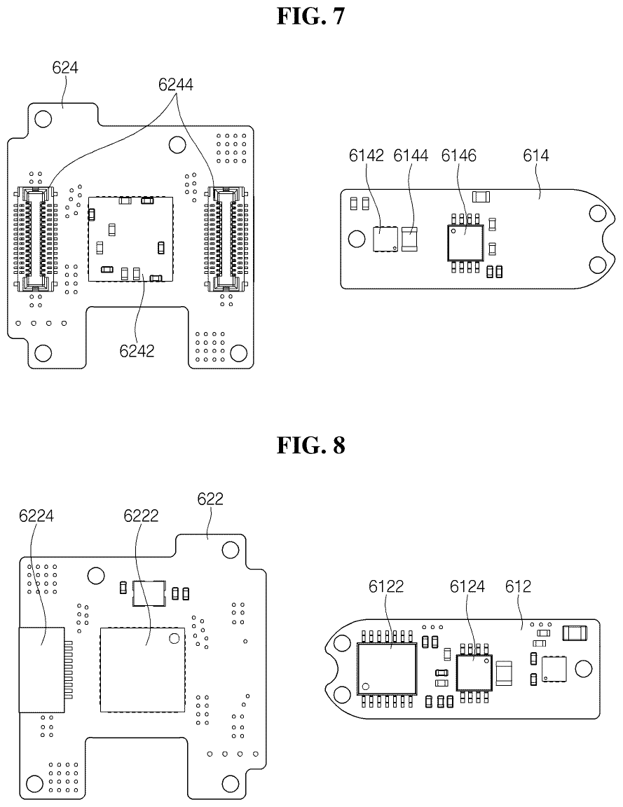

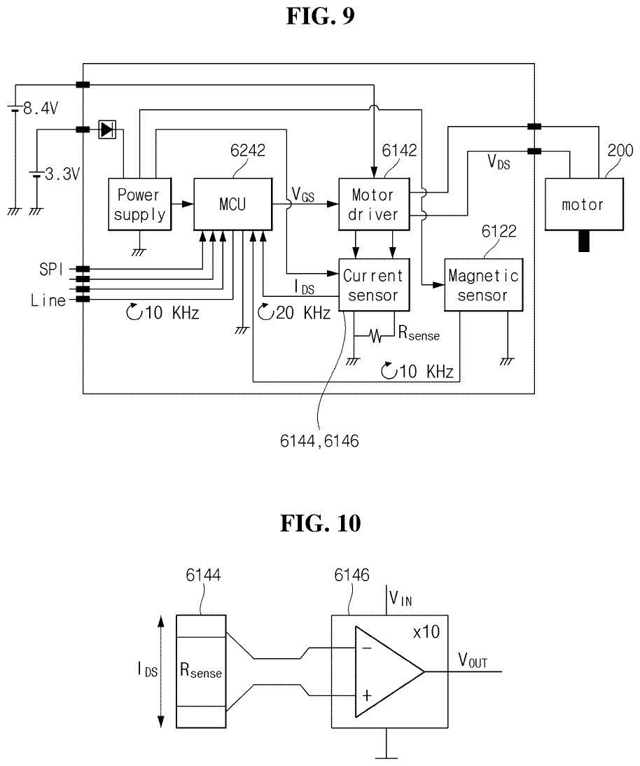

FIGS. 7 and 8 illustrate a substrate of a small actuator according to an embodiment of the present disclosure. FIG. 9 is a circuit diagram of a small actuator according to an embodiment of the present disclosure. FIG. 10 is a part of a circuit diagram of a small actuator according to an embodiment of the present disclosure.

Referring to FIGS. 7 to 10, the substrate 600 may include a magnet sensor 6122, a first cable connector 6124, a second cable connector 6222, a third cable connector 6224, a motor drive 6142, a current sensor (6144, 6146), an external connector 6244, and a controller 6242, but additional components are not excluded.

Specifically, the magnet sensor 6122 and the first cable connector 6124 may be arranged on an upper surface 612 of the inner substrate 610. The motor drive 6142 and the current sensor (6144, 6146) may be arranged on a lower surface 614 of the inner substrate 610. The external connector 6244 and the controller 6242 may be arranged on an outer surface 624 of the outer substrate 620. The second cable connector 6222 and the third cable connector 6224 may be arranged on an inner surface 622 of the outer substrate 620.

The magnet sensor 6122 may be disposed on the substrate 600. Specifically, the magnet sensor 6122 may be disposed on the upper surface 612 of the inner substrate 610. The magnet sensor 6122 may face the magnet 500. The magnet sensor 6122 may detect a rotation of the magnet 500. Specifically, the magnet sensor 6122 may detect a rotation angle and a rotation speed of the magnet 500. Through this, the magnet sensor 6122 can detect a rotation angle and a rotation speed of the output shaft 400.

The first cable connector 6124 may be disposed on the substrate 600. Specifically, the first cable connector 6124 may be disposed on the upper surface 612 of the inner substrate 610. The first cable connector 6124 may be electrically connected to the second cable connector 6222 of the outer substrate 620 via a cable. In this case, the cable connecting the first cable connector 6124 to the second cable connector 6222 may pass through the second housing 130.

The motor drive 6142 may be disposed on the substrate 600. Specifically, the motor drive 6142 may be disposed on the lower surface 614 of the inner substrate 610. The motor drive 6142 may be electrically connected to the motor 200. The motor drive 6142 may control a voltage or current applied to the motor 200. That is, the motor drive 6142 may control a drive of the motor 200.

The current sensor (6144, 6146) may be disposed on the substrate 600. Specifically, the current sensor (6144, 6146) may be disposed on the lower surface 614 of the inner substrate 610. The current sensor (6144, 6146) may be electrically connected to the motor 200. The current sensor (6144, 6146) may measure or detect the current flowing into the motor 200. Through this, the torque of the small actuator 10 can be detected by detecting the current flowing into the motor 200.

The current sensor (6144, 6146) may include a current amplifier 6146 and a current meter 6144. The current meter 6144 may be a shunt resistor. The shunt resistor is a type of a shunt resistor and is a resistor used when measuring the current. Through this, the current sensor (6144, 6146) may be configured in a small and light form.

The external connector 6244 may be disposed on the substrate 600. Specifically, the external connector 6244 may be disposed on the outer surface 624 of the outer substrate 620. The external connector 6244 may be connected to a cable that electrically connects the external connector 6244 to devices arranged to the outside.

The controller 6242 may be disposed on the substrate 600. Specifically, the controller 6242 may be disposed on the outer surface 624 of the outer substrate 620. The controller 6242 may be electrically connected to the magnet sensor 6122, the motor drive 6142, and the current sensor (6144, 6146). The controller 6242 may control the drive of the motor 200 through the motor drive 6142. The controller 6242 may detect the rotation speed and the rotation angle of the output shaft 400 through the magnet sensor 6122, and measure the current flowing into the motor 200 through the current sensor (6144, 6146). That is, the controller 6242 may predict the torque of the small actuator 10 through the current flowing into the motor 200 detected by the current sensor (6144, 6146), and control the operation of the motor 200 through the motor drive 6142 based on the predicted torque of the small actuator 10. Through this, the controller 6242 can perform fast torque feedback control. The controller 6242 may communicate with the external device. The controller 6242 can perform high-speed communication of 10 kHz or more with the external device. The controller 6242 may be referred to as a ‘micro controller unit (MCU)’.

The second cable connector 6222 may be disposed on the substrate 600. The second cable connector 6222 may be disposed on the inner surface 622 of the outer substrate 620. The second cable connector 6222 may be electrically connected to the first cable connector 6124 of the inner substrate 610 via a cable. In this case, the cable connecting the second cable connector 6222 and the first cable connector 6124 may be a flat cable.

The third cable connector 6224 may be disposed on the substrate 600. The third cable connector 6224 may be disposed on the inner surface 622 of the outer substrate 620. The third cable connector 6224 may be electrically connected to a cable that electrically connects the third cable connector 6224 to another sensor installed on the inner substrate 610 or the outer substrate 620 or another substrate.

Through this, since the signal processing device, the sensor, and the motor drive are configured as one body, maintenance of the small actuator 10 is easy, and the small actuator 10 can exchange data with an external device at high speed when the small actuator 10 is connected to the external device. Further, since an external connection method that allows bidirectional connection is provided, there is an advantage in that there is no need to connect the connectors considering the directions of the connectors. In addition, since the substrate on which the signal processing device is installed and the substrate on which the sensor and the driver are installed are manufactured to be separated from each other and can be easily connected through a commercial flat cable, replacement is easy in the event of a failure.

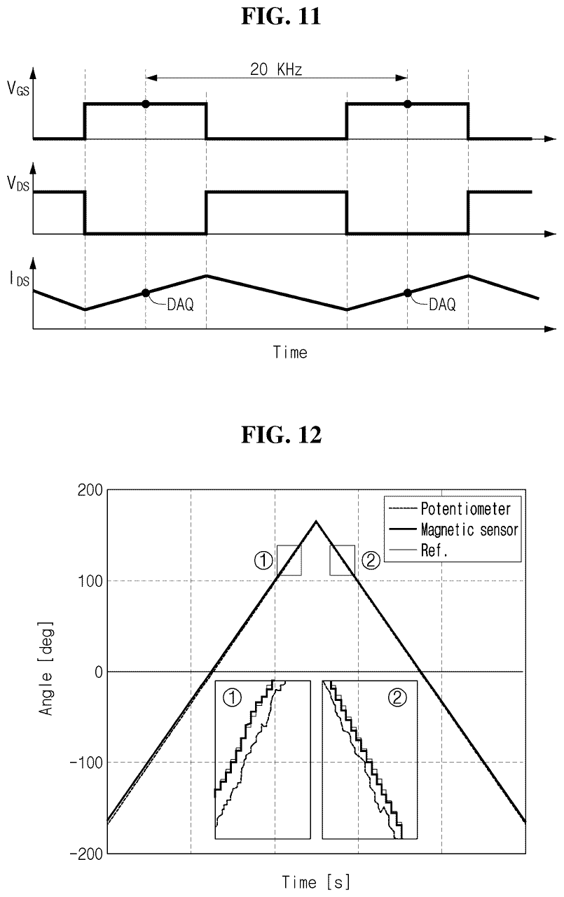

FIG. 11 is a graph illustrating a voltage and a current over time in a small actuator according to an embodiment of the present disclosure.

It can be seen from FIGS. 9 to 11 that a voltage VGS going from the controller 6242 to the motor drive 6142, a voltage VDS applied from the motor drive 6142 to the motor 200, and a current IDS actually flowing into the motor 200 over time can be known. Here, DAQ (data acquisition) can be interpreted as indicating a point at which data is measured.

That is, since the measurement is performed in synchronization with a digital signal that applies the current, the current measurement can be performed at a fast speed of 20 kHz. This can obtain more accurate current information than a method of detecting the current using a passive low-pass filter that utilizes a resistor and a capacitor.

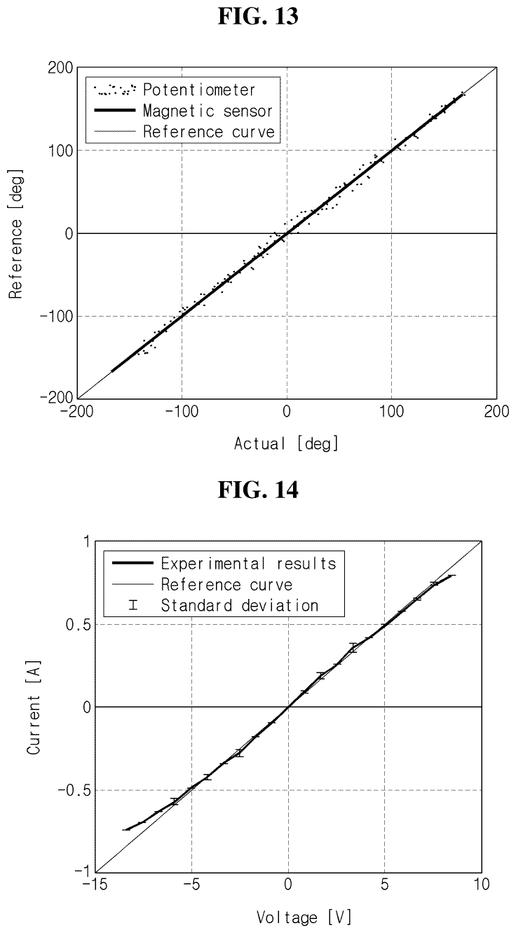

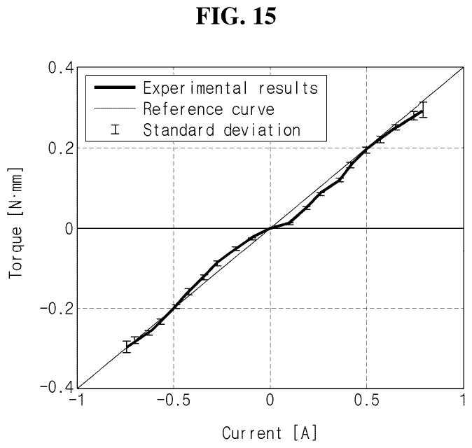

FIG. 12 is a graph illustrating a rotation angle of a magnet over time in a small actuator according to an embodiment of the present disclosure. FIG. 13 is a graph illustrating a relationship between an actual rotation angle and a reference rotation angle of a magnet of a small actuator according to an embodiment of the present disclosure. FIG. 14 is a graph illustrating a relationship between an input voltage and a measured current in a small actuator according to an embodiment of the present disclosure. FIG. 15 is a graph illustrating a relationship between a measured current and torque in a small actuator according to an embodiment of the present disclosure.

Since the small actuator 10 according to an embodiment of the present disclosure detects a magnetic field of the magnet 500 by utilizing the magnet sensor 6122 which is a rotary position detection sensor, the small actuator 10 has a high precision feature. In order to experimentally verify this feature through FIGS. 12 to 15, performance of the magnet sensor 6122 was compared with performance of a potentiometer which was mainly used in a conventional small actuator.

Specifically, referring to FIGS. 12 and 13, it could be experimentally seen that the potentiometer had a root mean square error (RMSE) of 0.66°, and the magnet sensor 6122 based on the magnet 500 had a root mean square error of 0.33°, which was about twice the position detection performance of the potentiometer.

The small actuator 10 according to an embodiment of the present disclosure can apply a voltage to the motor 200 and measure a current generated by the voltage, thereby calculating a torque that the small actuator 10 applies to the outside. In order to experimentally verify this, the voltage was applied to the small actuator 10, and a relationship between the input voltage and the measured current and a relationship between the measured current and the generated torque were analyzed. Specifically, referring to FIGS. 14 and 15, it could be seen that the experimental results showed a linear relationship between the input voltage and the measured current. That is, it can be seen that the small actuator 10 according to an embodiment of the present disclosure can be controlled by measuring the generated current and converting it into an external torque.

As described above, the embodiments of the present disclosure have been described with reference to the accompanying drawings, but those skilled in the art to which the present disclosure pertains will understand that the present disclosure can be embodied in other specific forms without changing its technical spirit or essential features. Therefore, it would be understood that the embodiments described above are illustrative in all respects, and not limited thereto.

What is claimed is:

1. A small actuator comprising:
a housing;
a motor disposed in the housing, the motor including a motor gear;
a first transmission gear including a first gear unit in external contact with the motor gear and a second gear unit formed integrally with the first gear unit;
a second transmission gear including a third gear unit in external contact with the second gear unit and a fourth gear unit formed integrally with the third gear unit;
a third transmission gear including a fifth gear unit in external contact with the fourth gear unit and a sixth gear unit formed integrally with the fifth gear unit;
a fourth transmission gear including a seventh gear unit in external contact with the sixth gear unit and an eighth gear unit formed integrally with the seventh gear unit; and
an output shaft including an output gear in external contact with the eighth gear unit,
wherein the second transmission gear and the fourth transmission gear vertically overlap each other, and
wherein the third transmission gear and the output shaft vertically overlap each other.

2. The small actuator of claim 1, wherein the second transmission gear, the third transmission gear, the fourth transmission gear, and the output gear are sequentially arranged in zigzag.

3. The small actuator of claim 1, wherein the third gear unit vertically overlaps the seventh gear unit as a whole, and
wherein the output gear vertically overlaps the fifth gear unit as a whole.

4. The small actuator of claim 3, wherein a diameter of the third gear unit is greater than a diameter of the fourth gear unit,
wherein a diameter of the seventh gear unit is greater than a diameter of the eighth gear unit, and
wherein a diameter of the fifth gear unit is greater than a diameter of the sixth gear unit.

5. The small actuator of claim 1, wherein the motor is a coreless direct current motor with a low inertia.

6. The small actuator of claim 1, further comprising:
a magnet disposed on the output shaft and below the third transmission gear;
a substrate disposed in the housing; and
a magnet sensor disposed on the substrate and facing the magnet.

7. The small actuator of claim 6, wherein the housing includes a first housing, a second housing disposed below the first housing, and a third housing connecting the first housing and the second housing, and
wherein the output shaft is rotatably coupled to the third housing through a bearing.

8. The small actuator of claim 7, further comprising a current sensor disposed on the substrate,
wherein the current sensor detects a current flowing into the motor.

9. The small actuator of claim 8, wherein the substrate includes an inner substrate coupled to the second housing and an outer substrate that is electrically connected to the inner substrate and is disposed outside the housing,
wherein the magnet sensor, the current sensor, and a motor drive are arranged on the inner substrate, and
wherein a controller is disposed on the outer substrate.

10. The small actuator of claim 8, further comprising:
a motor drive disposed on the substrate and controlling an operation of the motor; and
a controller disposed on the substrate and electrically connected to the current sensor and the motor drive,
wherein the controller predicts a torque of the small actuator through the current flowing into the motor detected by the current sensor, and controls the operation of the motor through the motor drive based on the predicted torque of the small actuator.

11. The small actuator of claim 6, wherein the third transmission gear is rotatably coupled to the output shaft.

12. The small actuator of claim 1, wherein the housing includes a first housing, a second housing disposed below the first housing, and a third housing connecting the first housing and the second housing,
wherein the small actuator further comprises a rotation shaft that is disposed inside the first transmission gear and is formed integrally with the first transmission gear, and
wherein the rotation shaft is rotatably coupled to the third housing.

13. The small actuator of claim 12, further comprising a fixing shaft, an upper portion of the fixing shaft being coupled to the first housing, a lower portion of the fixing shaft being coupled to the third housing,
wherein each of the second transmission gear and the fourth transmission gear is rotatably coupled to the fixing shaft.
